(19) United States
(12) Patent Application Publication
(10) Pub. No.: US 2019/0059341 A1
(43) Pub. Date: Feb. 28, 2019

(54) STRUCTURE OF AQUARIUM HEATER WITH OFF-WATER OVERHEAT PROTECTION

(71) Applicant: Wen-Hong Su, Taipei City (TW)

(72) Inventor: Wen-Hong Su, Taipei City (TW)

(21) Appl. No.: 15/782,808

(22) Filed: Oct. 12, 2017

(30) Foreign Application Priority Data
Aug. 24, 2017 (TW) 106212552

(51) Int. Cl. A01K 63/06; H05B 3/82

(52) U.S. Cl. CPC A01K 63/065; G05D 23/2033; H05B 3/82

(57) ABSTRACT

A structure of an aquarium heater with off-water overheat protection, wherein a control box with a control circuit is set inside. The control circuit includes: setting a temperature-control module; connecting with an electric heater; and connecting with either an overheat sensor or an off-water protection sensor; wherein the control circuit consists of a single chip, an electric relay box, and a plurality of resistors, capacitors, diodes, and transistors to constitute a complete electric circuit. Therefore, saving the electric energy and avoiding the conditions which the heating temperature is too high or the electric heater is emptily burned to damage because of the off-water can be achieved through the overheat sensor senses the temperature or the off-water protection sensor senses weather the electric heater is off water or not, and then the temperature-control module does the temperature comparison to control the electric heater to heat or not.

### (a) TECHNICAL FIELD OF THE INVENTION

The present invention relates to a structure of a heater, and more particularly, to a structure of an aquarium heater with off-water overheat protection.

### (b) DESCRIPTION OF THE PRIOR ART

Fish is a kind of variable temperature animal. Every kind of fish has its up and low limitation of optimum temperature for hot and cold endurance. The ingestion, respiration, and digestion functions of fish under the range of the optimum temperature will be vigorous, and the metabolic effects will be enhanced to make fish grow fast. If the living environment of the feeding aquatic fish is not controlled under the range of the appropriate temperature for a long term, the metabolic effects of the feeding aquatic fish will be abnormal, then its growth will be inhibited, and even leaded to death.

There are many people who feed fish as their pet all over the world. But, there are many environmental areas having different climates. The indoor temperature normally will not make the water temperature of the aquarium too low during the summer time. On the other hand, the water temperature of the aquarium will be lower down along with the indoor temperature decreases during the winter time. Nowadays, the heater has evolved to the electronic heater which has the ability to detect the water temperature and shut or start automatically.

However, there is no aquarium heater having the function of off-water overheat protection at the resent time. Therefore, the heating temperature is easy to be too high or the heater is easy to be emptily burned caused by the off-water. They are the defects needed to be improved for the conventional aquarium heater.

### SUMMARY OF THE INVENTION

The major objective of the present invention is to provide a structure of an aquarium heater with off-water overheat protection, which it can avoid the heating temperature being too high or the empty-burning caused by the off-water.

To achieve the objects mentioned above, a control box with a control circuit inside is set according to the present invention. Wherein, the control circuit includes: setting a temperature-control module; connecting with an electric heater; and connecting with either an overheat sensor or an off-water protection sensor; wherein the control circuit consists of a single chip, an electric relay box, and a plurality of resistors, capacitors, diodes, and transistors to constitute a complete electric circuit.

The effective benefits and advantages of the present invention are saving the electric energy and avoiding the conditions which the heating temperature is too high or the electric heater is emptily burned to damage because of the off-water through the overheat sensor senses the temperature or the off-water protection sensor senses weather the electric heater is off water or not, and then the temperature-control module does the temperature comparison to control the electric heater to heat or not.

### BRIEF DESCRIPTION OF THE DRAWINGS

FIG. 1 is a perspective-view exterior diagram according to the present invention.

FIG. 2 is a perspective-view decomposition diagram according to the present invention.

FIG. 3 is a detailed electric circuit diagram according to the present invention.

FIG. 4 is an electric circuit diagram of the off-water protection sensor according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following detailed description provides a convenient illustration for implementing exemplary embodiments of the invention. Various changes to the described embodiments may be made in the function and arrangement of the elements described without departing from the scope of the invention as set forth in the appended claims.

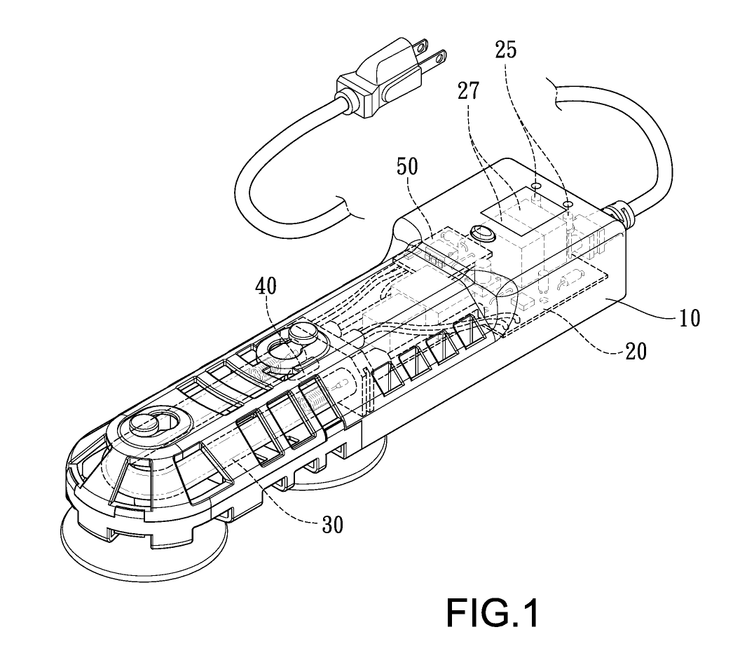

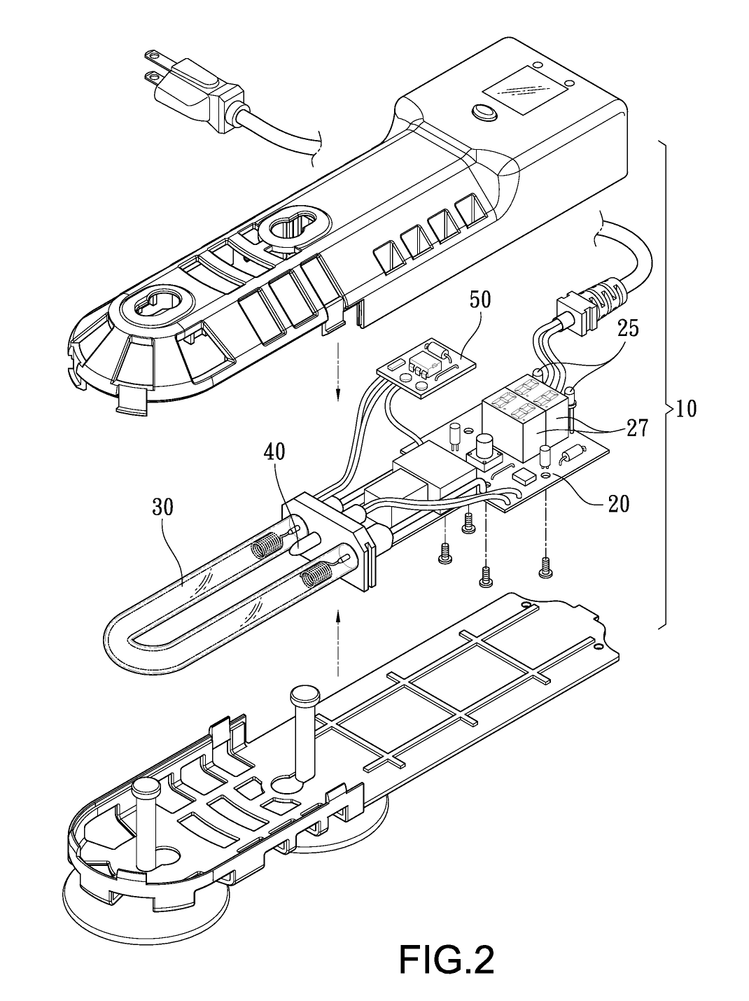

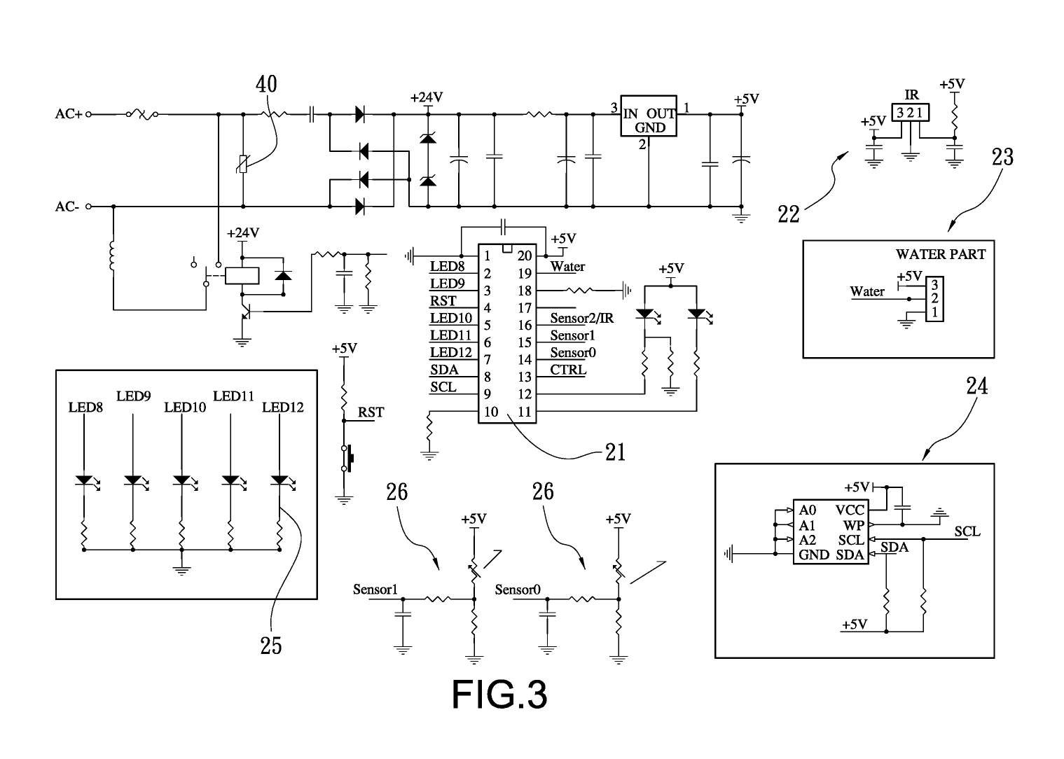

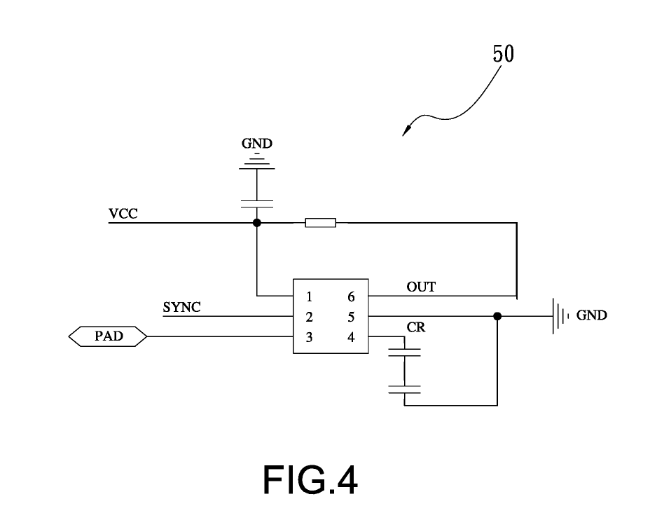

Please refer to FIG. 1, FIG. 2, FIG. 3, and FIG. 4, a control box 10 with a control circuit 20 inside is set according to the present invention. Wherein, the control circuit 20 includes: setting a temperature-control module; connecting with an electric heater 30; and connecting with an overheat sensor 40 or/and an off-water protection sensor 50. Wherein, the control circuit 20 consists of a single chip 21, an electric relay box, and a plurality of resistors, capacitors, diodes, and transistors to constitute a complete electric circuit.

According to one embodiment of the present invention, the off-water protection sensor 50 and the overheat sensor 40 may be applied separately or merged into a one-body heater.

According to one embodiment of the present invention, the control circuit 20 includes setting an IR receive module 22, an off-water power-off module 23, a data access module 24, a plurality of LEDs 25, two sensors 26, and two monitors 27.

The above explanation is to introduce the components and the way how they make up according to the present invention. Hereafter, the usage features, functions, and the effects of the present invention are then introduced in the following description.

When sensing the off-water, the off-water protection sensor 50 of the present invention will provide a signal to the temperature-control module and make the electric relay box open circuit, and the electric heater 30 will not be heated by electricity.

Besides, the overheat sensor 40 will provide a higher voltage to the temperature-control module to make the electric relay box open circuit, and the electric heater 30 will not be heated by electricity when the overheat sensor 40 of the present invention senses the temperature being too high which may be caused by the off-water.

The temperature-control module of the present invention also has the function of temperature sensing, which will make the electric relay box short circuit and the electric heater 30 will be heated by electricity when it senses the temperature being lower than the set-temperature and the off-water protection sensor 50 is still in the water, which the overheat sensor 40 does not exceed the set-temperature either.

When the temperature-control module receives a sensed temperature higher than or equal to the set-temperature, or the off-water protection sensor 50 judges an off-water condition, or the overheat sensor 40 receives a temperature higher than the set-temperature, the temperature-control module will make the electric relay box open circuit, and the electric heater 30 will not be heated by electricity if either one of the above three conditions is satisfied.

I claim:

1. A structure of an aquarium heater with off-water overheat protection, wherein a control box with a control circuit is set inside, which is characterized in that the control circuit comprises: setting a temperature-control module; connecting with an electric heater; and connecting with either an overheat sensor or an off-water protection sensor; wherein the control circuit consists of a single chip, an electric relay box, and a plurality of resistors, capacitors, diodes, and transistors to constitute a complete electric circuit; therefore saving the electric energy and avoiding the conditions which the heating temperature is too high or the electric heater is emptily burned to damage because of the off-water can be achieved through the overheat sensor senses the temperature or the off-water protection sensor senses weather the electric heater is off water or not, and then the temperature-control module does the temperature comparison to control the electric heater to heat or not.

2. The structure of an aquarium heater with off-water overheat protection according to claim 1, wherein the control circuit comprises setting an IR receive module, an off-water power-off module, a data access module, a plurality of LEDs, two sensors, and two monitors.
